(19) United States
(12) Patent Application Publication
(10) Pub. No.: US 2014/0045094 A1
(43) Pub. Date: Feb. 13, 2014

(54) PPS Membrane Reinforcing Material

(71) Applicants: James Mitchell, Bloomfield, NY (US); Timothy J. Fuller, Pittsford, NY (US)

(72) Inventors: James Mitchell, Bloomfield, NY (US); Timothy J. Fuller, Pittsford, NY (US)

(73) Assignee: GM GLOBAL TECHNOLOGY OPERATIONS LLC, Detroit, MI (US)

(21) Appl. No.: 13/568,502

(22) Filed: Aug. 7, 2012

(51) Int. Cl. H01M 8/10

(52) U.S. Cl. 429/482; 264/104

(57) ABSTRACT

A metal electrode assembly for a fuel cell includes a cathode catalyst layer, an anode catalyst layer, and an ion-conducting membrane disposed between the cathode catalyst layer and the anode catalyst layer. The ion-conducting membrane includes a first polymer and polyphenylene sulfide-containing structures dispersed within the first polymer, the first polymer including protogenic groups. A method for making the ion-conducting membrane is also provided.

The present invention relates to methods for making fuel cell ion-conducting membranes.

### BACKGROUND OF THE INVENTION

In proton exchange membrane type fuel cells, hydrogen is supplied to the anode as fuel, and oxygen is supplied to the cathode as the oxidant. The oxygen can either be in pure form (O₂) or air (a mixture of O₂ and N₂). Proton exchange membrane (“PEM”) fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Typically, the ion conductive polymer membrane includes a perfluorosulfonic acid (PFSA) ionomer.

Each catalyst layer has finely divided catalyst particles (for example, platinum particles), supported on carbon particles, to promote oxidation of hydrogen at the anode, and reduction of oxygen at the cathode. Protons flow from the anode through the ion conductive polymer membrane to the cathode where they combine with oxygen to form water which is discharged from the cell.

The MEA is sandwiched between a pair of porous gas diffusion layers (“GDL”), which in turn are sandwiched between a pair of electrically conductive flow field elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cells in stacks in order to provide high levels of electrical power.

In many fuel cell applications, electrode layers are formed from ink compositions that include a precious metal and a perfluorosulfonic acid polymer (PFSA). For example, PFSA is typically added to the Pt/C catalyst ink in electrode layer fabrication of proton exchange membrane fuel cells to provide proton conduction to the dispersed Pt nanoparticle catalyst as well as binding of the porous carbon network. Traditional fuel cell catalysts combine carbon black with platinum deposits on the surface of the carbon, along with ionomers. The carbon black provides (in part) a high surface area conductive substrate. The platinum deposits provide a catalytic behavior, and the ionomers provide a proton conductive component. The electrode is formed from an ink that contains the carbon black catalyst and the ionomer, which combine on drying to form an electrode layer. Although the current technologies for making the ion-conducting membranes work reasonably well, there is still a need for improvement.

Accordingly, the present invention provides improved methods of making membranes that are useful in fuel cell applications.

### SUMMARY OF THE INVENTION

The present invention solves one or more problems of the prior art by providing in at least one embodiment a metal electrode assembly for a fuel cell. The metal electrode assembly includes a cathode catalyst layer, an anode catalyst layer, and an ion-conducting membrane disposed between the cathode catalyst layer and the anode catalyst layer. The ion-conducting membrane includes a first polymer and polyphenylene sulfide-containing structures dispersed within the first polymer, the first polymer including protogenic groups.

In another embodiment, a method of forming an ion-conducting membrane is provided. The method includes a step of combining a polyphenylene sulfide-containing resin with a water soluble carrier resin to form a resinous mixture. The resinous mixture is then shaped to form a shaped resinous mixture. The shaped resinous mixture has polyphenylene sulfide-containing structures dispersed within the carrier resin. The shaped resinous mixture is contacted with water to separate the polyphenylene sulfide-containing structures from the carrier resin. The polyphenylene sulfide-containing structures are optionally sulfonated. The polyphenylene sulfide-containing structures are combined with a first polymer to form a polymeric composition. The polymeric composition into the ion-conducting membrane with the sulfide-containing structures dispersed within the carrier resin.

Advantageously, polyphenylene sulfide and/or sulfonated polyphenylene sulfide (S-PPS)-containing structures fibers are added to the ionomeric membranes to improve durability and resistance to electrical shorting. PPS and S-PPS nanofibers are more structurally stable than expanded polytetrafluoroethylene web (ePTFE) currently used to reinforce polyelectrolyte membranes since the PPS and S-PPS nanofibers do not deform under pressure. The addition of sulfuric acid groups to the PPS (to form S-PPS) offers the advantage that the fibers are proton conductive like the membrane itself, while ePTFE used as a membrane support is not. Moreover, the PPS and S-PPS nanofibers readily disperse into water and alcohols, and are not electrically conductive, making them an excellent membrane reinforcement additive.

### BRIEF DESCRIPTION OF THE DRAWINGS

Exemplary embodiments of the present invention will become more fully understood from the detailed description and the accompanying drawings, wherein:

FIG. 1 provides a schematic illustration of a fuel cell incorporating a separator;

FIG. 2 is a schematic flow chart showing the fabrication of a membrane using polyphenylene sulfide fibers;

FIG. 3A provides a scanning electron micrograph of poly(phenylene sulfide) nanofibers; and

FIG. 3B provides a scanning electron micrograph of ePTFE fibers.

### DESCRIPTION OF THE INVENTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; molecular weights provided for any polymers refers to weight average molecular weight unless indicated otherwise; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

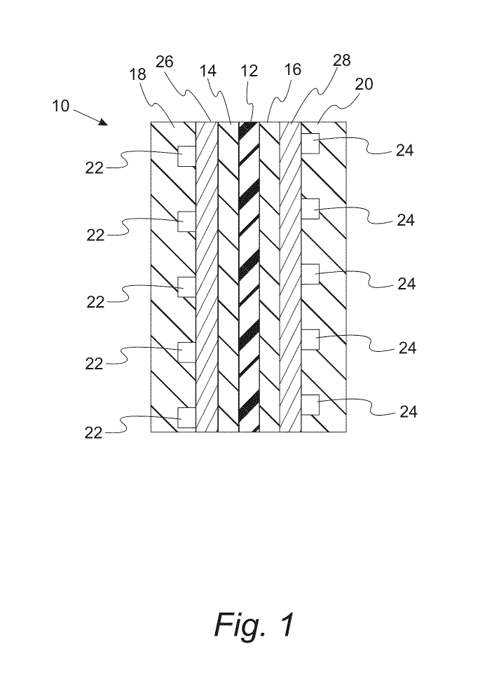

With reference to FIG. 1, a schematic cross section of a fuel cell that incorporates an embodiment of a fibrous sheet is provided. Proton exchange membrane (PEM) fuel cell 10 includes polymeric ion-conducting membrane 12 disposed between cathode catalyst layer 14 and anode catalyst layer 16. Fuel cell 10 also includes flow field plates 18, 20, gas channels 22 and 24, and gas diffusion layers 26 and 28. Advantageously, polymeric ion-conducting membrane 12 includes polyphenylene sulfide structures and in particular, polyphenylene sulfide fibers as set forth below. Hydrogen ions generated by anode catalyst layer 16 migrate through polymeric ion-conducting membrane 12 were they react at cathode catalyst layer 14 to form water. This electrochemical process generates an electric current through a load connected to flow field plates 18 and 20.

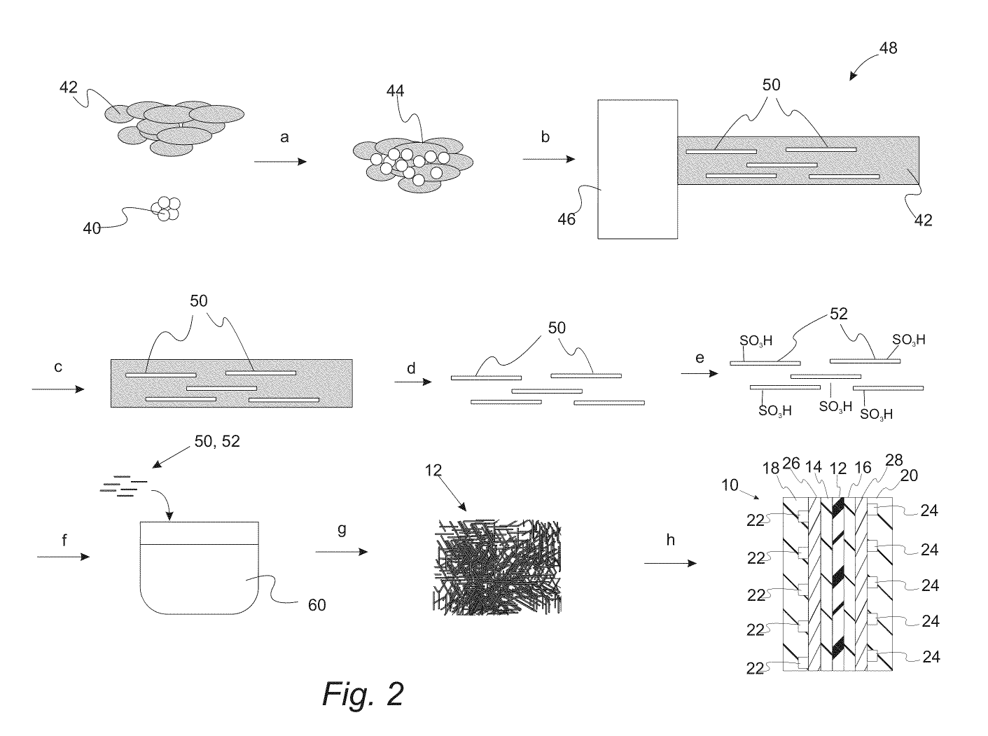

With reference to FIG. 2, a schematic flow chart illustrating a method for making a polyphenylene sulfide-containing membrane is provided. In step a), polyphenylene sulfide-containing resin 40 is combined with water soluble carrier resin 42 to form resinous mixture 44. In a refinement, the weight ratio of polyphenylene sulfide-containing resin 40 to water soluble carrier resin 42 is 1:100 to about 10:1. In another refinement, the weight ratio of polyphenylene sulfide-containing resin 40 to water soluble carrier resin 42 is 1:50 to about 10:1. In still another refinement, the weight ratio of polyphenylene sulfide-containing resin 40 to water soluble carrier resin 42 is 1:10 to about 10:1. In step b), resinous mixture 44 is shaped. The shaping of the resinous mixture affects the shape of the polyphenylene sulfide-containing resin therein through the action of various forces (e.g., friction, shearing forces, etc.) transmitted to the polyphenylene sulfide-containing resin. FIG. 2 depicts a particular example in which resinous mixture 44 is extruded to form fibers. Therefore, resinous mixture 44 is extruded from extruder 46 in step b) to form extruded resinous mixture 48. In other variations, the polyphenylene sulfide is in the form of beads, spheres, and oblong shapes. In a refinement of these variations, the polyphenylene sulfide has an average spatial dimension (e.g., a width) from about 5 nanometers to about 10 microns. Extruded resinous mixture 48 includes polyphenylene sulfide-containing fibers 50 within carrier resin 42. In step c), the extruded fiber is optionally separated from extruder 46. In step d), polyphenylene sulfide-containing fibers 50 are freed from the fiber by contacting/washing in water. In step e), protogenic groups (PG) are optionally added to the polyphenylene sulfide-containing fibers to form modified polyphenylene sulfide-containing fibers 52:

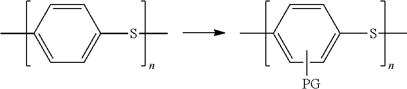

wherein PG is —SO₂X, —PO₃H₂, and —COX, and where X is an —OH, a halogen, or an ester and n is a number from about 20 to about 500 on average. In particular, the polyphenylene sulfide-containing fibers are sulfonated (SO₃H) in this step. Typically, polyphenylene sulfide-containing fibers 50 and/or 52 have an average width from about 5 nanometers to about 30 microns. In another refinement, polyphenylene sulfide fibers 32 have an average width from about 5 nanometers to about 10 microns. In still another refinement, polyphenylene sulfide fibers 32 have an average width of from about 10 nanometers to about 5 microns. In still another refinement, polyphenylene sulfide fibers 32 have an average width of from about 100 nanometers to about 5 microns. In still another variation, polyphenylene sulfide fibers 32 have an average width of from about 50 nanometers to about 400 nm.

In step f), polyphenylene sulfide-containing fibers 50 and/or 52 are combined with a first polymer. In the example depicted in FIG. 2, polymer composition 60 includes a solvent, the first polymer and polyphenylene sulfide-containing fibers 50 and/or 52 dispersed therein. This dispersal may be accomplished by sonication, mixing, and combinations thereof. Typically, the first polymer is an ion-conducting polymer that includes protogenic groups as set forth above. Suitable solvents include alcohols (e.g., methanol, alcohol, propanol, and the like) and water. Examples for the first polymer include, but are not limited to, perfluorsulfonic acid polymers such as NAFION™, perfluorocyclobutyl-containing polymer (PFCBs), and combinations thereof. Examples of useful PFSA polymers include a copolymer containing a polymerization unit based on a perfluorovinyl compound represented by:

CF₂═CF—(OCF₂CFX¹)ₘ—Oᵣ—(CF₂)_{q}—SO₃H

where m represents an integer of from 0 to 3, q represents an integer of from 1 to 12, r represents 0 or 1, and X¹ represents a fluorine atom or a trifluoromethyl group and a polymerization unit based on tetrafluoroethylene. Suitable polymers having cyclobutyl moieties are disclosed in U.S. Pat. Pub. No. 2007/0099054, U.S. Pat. Nos. 7,897,691 issued Mar. 1, 2011; 7,897,692 issued Mar. 1, 2011; 7,888,433 issued Feb. 15, 2011, 7,897,693 issued Mar. 1, 2011; and 8,053,530 issued Nov. 8, 2011, the entire disclosures of which are hereby incorporated by reference. In a variation, the ion-conducting polymer having perfluorocyclobutyl moieties includes a polymer segment comprising polymer segment 1:

E₀-P₁-Q₁-P₂ 1

wherein:
E₀ is a moiety, and in particular, a hydrocarbon-containing moiety, that has a protogenic group such as —SO₂X, —PO₃H₂, —COX, and the like;
P₁, P₂ are each independently absent, —O—, —S—, —SO—, —CO—, —SO₂—, —NH—, NR₂—, or —R₃—;
R₂ is C₁₋₂₅ alkyl, C₆₋₂₅ aryl or C₆₋₂₅ arylene;
R₃ is C₁₋₂₅ alkylene, C₂₋₂₅ perfluoroalkylene, C₂₋₂₅ perfluoroalkyl ether, C₂₋₂₅ alkylether, or C₆₋₂₅ arylene;
X is an —OH, a halogen, an ester, or

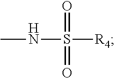

R₄ is trifluoromethyl, C₁₋₂₅ alkyl, C₂₋₂₅ perfluoroalkylene, or C₆₋₂₅ aryl; and
Q₁ is a perfluorinated cyclobutyl moiety.
   Examples for Q₁ and Q₂ in the above formulae are:

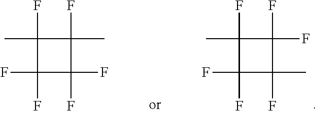

In a refinement, E₀ is a C₆₋₃₀ aromatic (i.e., aryl) containing group.

In step g), composition 60 is then coated out on a substrate and then dried (i.e., solvent allowed to evaporated or removed) to form ion-conducting membrane 12. In a variation of the present embodiment, membrane 12 has a thickness from about 5 microns to about 2 mm. In a refinement, membrane 30 has a thickness from about 5 microns to about 500 microns. In another refinement, membrane 30 has a thickness from about 5 microns to about 50 microns. In step h), the membrane formed in step g) is incorporated into fuel cell 10.

As set forth above, the method of the invention utilizes water soluble resins. Examples of suitable water-soluble resins include, but are not limited to, water-soluble polyamides (e.g., poly(2-ethyl-2-oxazoline) (“PEOX”). In a refinement, the PEOX has a number average molecular weight from about 40,000 to about 600,000. Number average molecular weights of 200,000 and 500,000 have been found to be particularly useful.

In a refinement of the present invention for the variations and embodiments set forth above, the polyphenylene sulfide fibers (with or without protogentic groups) have an average cross sectional width (i.e., diameter when the fibers have a circular cross section) from about 5 nanometers to about 30 microns. In another refinement, the fibers have an average width of about 5 nanometers to about 10 microns. In still another refinement, the fibers have an average width of from about 10 nanometers to about 5 microns. In still another refinement, the fibers have an average width of from about 100 nanometers to about 5 microns. The length of the fibers typically exceeds the width. In a further refinement, the fibers produced by the process of the present embodiment have an average length from about 1 mm to about 20 mm or more. Other ionomers such as TCT 891 (a PFSA multiblock PFCB polymer from Tetramer Technologies, LLC) can be used instead of NAFION™ DE2020 ionomer solution, with or without KynarFlex 5721 in polar aprotic solvents or in alcohol solvents.

In a variation, the ion-conducting membrane also includes a second polymer. Examples of the second polymer include fluoroelastomers. The fluoro-elastomer may be any elastomeric material comprising fluorine atoms. The fluoro-elastomer may comprise a fluoropolymer having a glass transition temperature below about 25° C. or preferably, below 0° C. The fluoro-elastomer may exhibit an elongation at break in a tensile mode of at least 50% or preferably at least 100% at room temperature. The fluoro-elastomer is generally hydrophobic and substantially free of ionic groups. The fluoro-elastomer may be prepared by polymerizing at least one fluoro-monomer such as vinylidene fluoride, tetrafluoroethylene, hexafluoropropylene, vinylfluoride, chlorotrifluoroethylene, perfluoromethylvinyl ether, and trifluoroethylene. The fluoro-elastomer may also be prepared by copolymerizing at least one fluoro-monomer and at least one non-fluoro-monomer such as ethylene, propylene, methyl methacrylate, ethyl acrylate, styrene, vinylchloride and the like. The fluoro-elastomer may be prepared by free radical polymerization or anionic polymerization in bulk, emulsion, suspension and solution. Examples of fluoro-elastomers include poly(tetrafluoroethlyene-co-ethylene), poly(vinylidene fluoride-co-hexafluoropropylene), poly(tetrafluoroethylene-co-propylene), terpolymer of vinylidene fluoride, hexafluoropropylene and tetrafluoroethylene, and terpolymer of ethylene, tetrafluoroethylene and perfluoromethylvinylether. Some of the fluoro-elastomers are commercially available from Arkema under trade name Kynar Flex® and Solvay Solexis® under the trade name Technoflon®, from 3M under the trade name Dyneon®, and from DuPont under the trade name Viton®. For example, Kynar Flex® 2751 is a copolymer of vinylidene fluoride and hexafluoropropylene with a melting temperature between about 130° C. and 140° C. The glass transition temperature of Kynar Flex® 2751 is about −40 to −44° C. The fluoro-elastomer may further comprise a curing agent to allow crosslinking reaction after being blended with the second polymer. In a refinement, the first polymer is present in an amount from about 1 to about 50 weight percent and the second polymer is present in an amount from about 50 to about 99 weight percent of the combined weight of the first and second polymers. In a further refinement, the first polymer is present in an amount from about 2 to about 40 weight percent and the second polymer is present in an amount from about 60 to about 98 weight percent of the combined weight of the first and second polymers. In still a further refinement, the first polymer is present in an amount from about 5 to about 25 weight percent and the second polymer is present in an amount from about 75 to about 95 weight percent of the combined weight of the first and second polymers.

The following examples illustrate the various embodiments of the present invention. Those skilled in the art will recognize many variations that are within the spirit of the present invention and scope of the claims.

### Preparation of PPS Nanofibers.

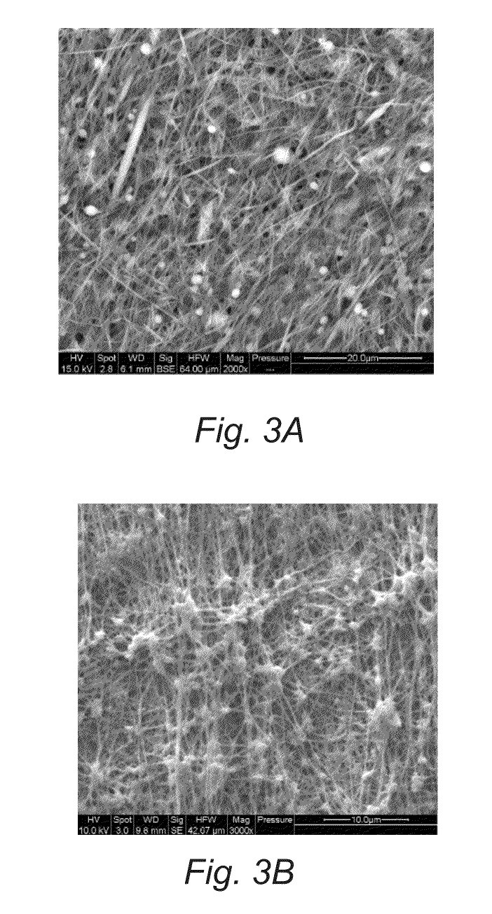

Polyphenylene sulfide (PPS) thermoplastic fibers are created by first dispersing PPS in 500,000 MW water-soluble poly(2-ethyl-2-oxazoline) (PeOX). Specifically, 5 grams of PPS is first blended in a Waring blender with 15 grams of 500,000 MW PeOX (at a ratio of 1 to 3). The combined blend is added to a laboratory mixing extruder (Dynisco, LME) operated at 240° C. header and rotor temperatures with the drive motor operated at 50% of capacity, resulting in an extruded strand of the blend. This extruded strand is added to the blender to return it to granular form, and then the granules are re-extruded two more times, creating a uniform extruded strand. During the final extrusion processes, the fibers are stretched and spun onto a take-up wheel (a Dynisco Take-Up System (TUS), at approximately 10 cm/second. The resulting extruded strand is washed in reverse osmosis (R.O.) water with repeated rinses, until the PeOX has been removed, resulting in a sample of PPS nanofibers. The fibers are then rinsed in isopropyl alcohol, filtered, and allowed to dry completely overnight. FIG. 3A provides a micrograph of poly(phenylene sulfide) nanofibers while FIG. 3B provides a micrograph of ePTFE fibers.

### Preparation of Sulfonated PPS Nanofibers.

The polyphenylene sulfide nanofibers are sulfonated in a way that does not reduce the high surface area form of the PPS back to a sheet form. Nanofibers of polyphenylene sulfide (2 grams) are suspended in methylene chloride (50 g) in a screw-cap jar with a Teflon gasketed lid. Chlorosulfonic acid is first dispersed in methylene chloride (1 gram in approximately 100 g). With vigorous stirring, chlorosulfonic acid dispersion (1 g of acid) in methylene chloride (50 mL) is added to the dispersion of PPS fibers in methylene chloride and the lid is secured. The jar is roll-milled for 4 hours and then the dark green-blue fibrous mixture is added to water (1 L), boiled for 1 hour, and is stirred at 23° C. for 16 hours. The sulfonated fibers are washed extensively with water and filtered onto a polypropylene mat (SeFar America). The ion exchange capacity of the fibers is 1.03 meq H⁺/g. The reaction is repeated using two grams of chlorosulfonic acid and two grams of nanofibers of polyphenylene sulfide. The ion exchange capacity of the resultant fibers is 1.3 meq H⁺/g. The resulting nanofibers of polyphenylene sulfide with sulfonic acid groups are referred to as S-PPS fibers.

Sonication of PPS Nanofibers.

Effectively dispersing the fibers is a vital step in the process of introducing them to the membrane as a reinforcing component. PPS nanofibers (0.10 g) are added to 3.33 grams of water and 6.67 grams of ethanol. The mixture is sonicated using a Misonix 3000 ultrasonic homogenizer for 5 minutes, set to a pulse mode of 10 seconds on and 10 seconds off at 18 Watts.

### Example 1

### PPS Nanofiber PEM Reinforcement

Nafion DE2020 ionomer solution (DuPont de Nemours) and between 5 and 25 wt. % of PPS nano-fibers are added based on the mass of ionomer solids. The nano-fibers are then sonicated using a Misonix 3000 ultrasonic homogenizer for 5 minutes, set to a pulse mode of 10 seconds on and 10 seconds off at 18 Watts. Membranes are cast by coating the ionomer-nanofiber dispersion onto Kapton-PTFE backer sheet (American Durofilm) situated on a vacuum platen of an Erichsen coater operated at 12.5 mm/sec using a 3-mil Bird applicator. The coated wet film and backer sheet are then heated to 80° C. on the platen, and then the film coating on the backer is transferred to an oven and heated to 140° C. After 16 hours at 140° C., the coated film is removed from the oven, released from the backer and used as polyelectrolyte membrane in a fuel cell.

### Example 2

### S-PPS Nanofiber PEM Reinforcement

Nafion DE2020 ionomer solution (DuPont de Nemours) and between 5 and 25 wt. % of S-PPS nano-fibers are added based on the mass of ionomer solids. The nano-fibers are then sonicated using a Misonix 3000 ultrasonic homogenizer for 5 minutes, set to pulse mode of 10 seconds on and 10 seconds off at 18 Watts. Membranes are cast by coating the ionomer-nanofiber dispersion onto Kapton-PTFE backer sheet (American Durofilm) situated on a vacuum platen of an Erichsen coater operated at 12.5 mm/sec using a 3-mil Bird applicator. The coated wet film and backer sheet are then heated to 80° C. on the platen, and then the film coating on backer is transferred to an oven and heated to 140° C. After 16 hours at 140° C., the coated film reinforced with nanofiber S-PPS is removed from the oven, released from the backer and used as polyelectrolyte membrane in a fuel cell.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A metal electrode assembly for a fuel cell, the metal electrode assembly comprising:
a cathode catalyst layer;
an anode catalyst layer; and
an ion-conducting membrane disposed between the cathode catalyst layer and the anode catalyst layer, the ion-conducting membrane including a first polymer and polyphenylene sulfide-containing structures dispersed within the first polymer, the first polymer including protogenic groups.

2. The metal electrode assembly of claim 1 wherein the polyphenylene sulfide-containing structures include a component selected from the group consisting of fibers, beads, spheres, and oblong shapes.

3. The metal electrode assembly of claim 1 wherein protogenic groups are added to the polyphenylene sulfide structures.

4. The metal electrode assembly of claim 3 wherein the protogenic groups are SO₂X, —PO₃H₂, or —COX where X is an —OH, a halogen, or an ester.

5. The metal electrode assembly of claim 1 wherein the polyphenylene sulfide-containing structures have an average spatial dimension from about 5 nanometers to about 10 microns.

6. The metal electrode assembly of claim 1 wherein the ion-conducting membrane has an average thickness from about 5 microns to about 25 microns.

7. The metal electrode assembly of claim 1 wherein the first polymer is selected from the group consisting of perfluorosulfonic acid polymer, perfluorocyclobutyl-containing polymers and combinations thereof.

8. The metal electrode assembly of claim 1 wherein the perfluorosulfonic acid polymer includes a copolymer containing a polymerization unit based on a perfluorovinyl compound represented by:
CF₂═CF—(OCF₂CFX¹)ₘ—Oᵣ—(CF₂)_{q}—SO₃H
where m represents an integer of from 0 to 3, q represents an integer of from 1 to 12, r represents 0 or 1, and X¹ represents a fluorine atom or a trifluoromethyl group and a polymerization unit based on tetrafluoroethylene.

9. The metal electrode assembly of claim 7 wherein the perfluorocyclobutyl-containing polymer includes a polymer segment comprising polymer segment 1:
E₀-P₁-Q₁-P₂ 1
wherein:
E₀ is a moiety, and in particular, a hydrocarbon-containing moiety, that has a protogenic group such as —SO₂X, —PO₃H₂, —COX, and the like;
P₁, P₂ are each independently absent, —O—, —S—, —SO—, —CO—, —SO₂—, —NH—, NR₂₋₅ or —R₃—;
R₂ is C₁₋₂₅ alkyl, C₁₋₂₅ aryl or C₁₋₂₅ arylene;
R₃ is C₂₋₂₅ alkylene, C₂₋₂₅ perfluoroalkylene, C₂₋₂₅ perfluoroalkyl ether, C₂₋₂₅ alkylether, or C₆₋₂₅ arylene;
X is an —OH, a halogen, an ester, or 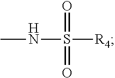
R₄ is trifluoromethyl, C₁₋₂₅ alkyl, C₂₋₂₅ perfluoroalkylene, C₆₋₂₅ aryl; and
Q₁ is a perfluorinated cyclobutyl moiety.

10. A fuel cell incorporating the metal electrode assembly of claim 1.

11. A method comprising:
combining a polyphenylene sulfide-containing resin with a water soluble carrier resin to form a resinous mixture;
shaping the resinous mixture to form a shaped resinous mixture, the shaped resinous mixture having polyphenylene sulfide-containing structures within the carrier resin;
contacting the shaped resinous mixture with water to separate the polyphenylene sulfide-containing structures from the carrier resin;
optionally sulfonating the polyphenylene sulfide-containing structures;
combining the polyphenylene sulfide-containing structures with a first polymer to form a polymeric composition; and
forming the polymeric composition into a membrane with the polyphenylene sulfide-containing structures dispersed within the carrier resin.

12. The method of claim 11 wherein the polyphenylene sulfide-containing structures include a component selected from the group consisting of fibers, beads, spheres, and oblong shapes.

13. The method of claim 11 wherein protogenic groups are added to the polyphenylene sulfide-containing resin.

14. The method of claim 13 wherein the protogenic groups are —SO₂X, —PO₃H₂, or —COX where X is an —OH, a halogen, or an ester.

15. The method of claim 11 wherein the carrier resin is a water-soluble polyamide.

16. The method of claim 11 wherein the carrier resin comprises poly(2-ethyl-2-oxazoline).

17. The method of claim 11 wherein the weight ratio of polyphenylene sulfide-containing resin to carrier resin is from about 1:10 to about 10:1.

18. The method of claim 11 wherein the polyphenylene sulfide-containing structures have an average spatial dimension from about 5 nanometers to about 10 microns.

19. The method of claim 11 wherein the membrane has an average thickness from about 5 microns to about 50 microns.
